(19) United States
(12) Patent Application Publication
(10) Pub. No.: US 2008/0124227 A1
(43) Pub. Date: May 29, 2008

(54) Maintenance Tray of an Oxygen Machine

(76) Inventor: Shao-Shih Huang, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/563,378

(22) Filed: Nov. 27, 2006

(51) Int. Cl. F04B 53/00; B23Q 3/00

(52) U.S. Cl. 417/234; 269/16

(57) ABSTRACT

A maintenance tray of an oxygen machine is secured to a case of the oxygen machine and comprises a base board, a pair of handles, a pair of locators and fasteners. The base board comprises a front end and a rear end. The handles are formed at the front end of the base board, and the locators are formed at the rear end of the base board. The fasteners are used to secure the base board to the case so as to easily dissemble the parts for maintenance.

### BACKGROUND OF THE INVENTION

1. Field of the Invention

The present invention relates to a maintenance tray of an oxygen machine, in particular to a maintenance tray provided with a fan, an electromagnetic valve and a compressor to be secured to a case for easily dismantling parts for maintenance.

2. Description of the Prior Art

A conventional oxygen machine has its parts all secured in a case. When doing maintenance, many parts are required to be dismantled, which requires more man power and increases the cost.

### SUMMARY OF THE INVENTION

It is the primary object of the present invention to provide a maintenance tray of an oxygen machine, which is easy to operate.

It is another object of the present invention to provide a maintenance tray of an oxygen machine, which saves man power and the cost of manufacture.

It is a further object of the present invention to provide a maintenance tray of an oxygen machine, which is easy to maintain and to repair.

According to the present invention, there is provided a maintenance tray of an oxygen machine, said maintenance tray being secured to a case, said case comprising locking holes, locating holes and stop plates, said maintenance tray comprising a base board having a front end, a rear end and through holes in relation to said locking holes of said case; a pair of handles formed at said front end of said base board; a pair of locators formed at said rear end of said base board comprising protuberances and ribs, said protuberances corresponding in position to said locating holes of said case, and said ribs corresponding in position to said stop plates of said case; fasteners being inserted through said through holes of said base board and secured to said locking holes of said case.

### BRIEF DESCRIPTION OF THE DRAWINGS

FIG. 1 is an exploded view of a preferred embodiment of the present invention combined with a fan, an electromagnetic valve and a compressor;

FIG. 2 is a perspective view of the preferred embodiment of the present invention combined with the fan, the electromagnetic valve and the compressor; and

FIG. 3 is a side cross-sectional view of the present invention combined with the fan, the electromagnetic valve and the compressor in an operating status.

### DETAILED DESCRIPTION OF THE PREFERRED EMBODIMENT

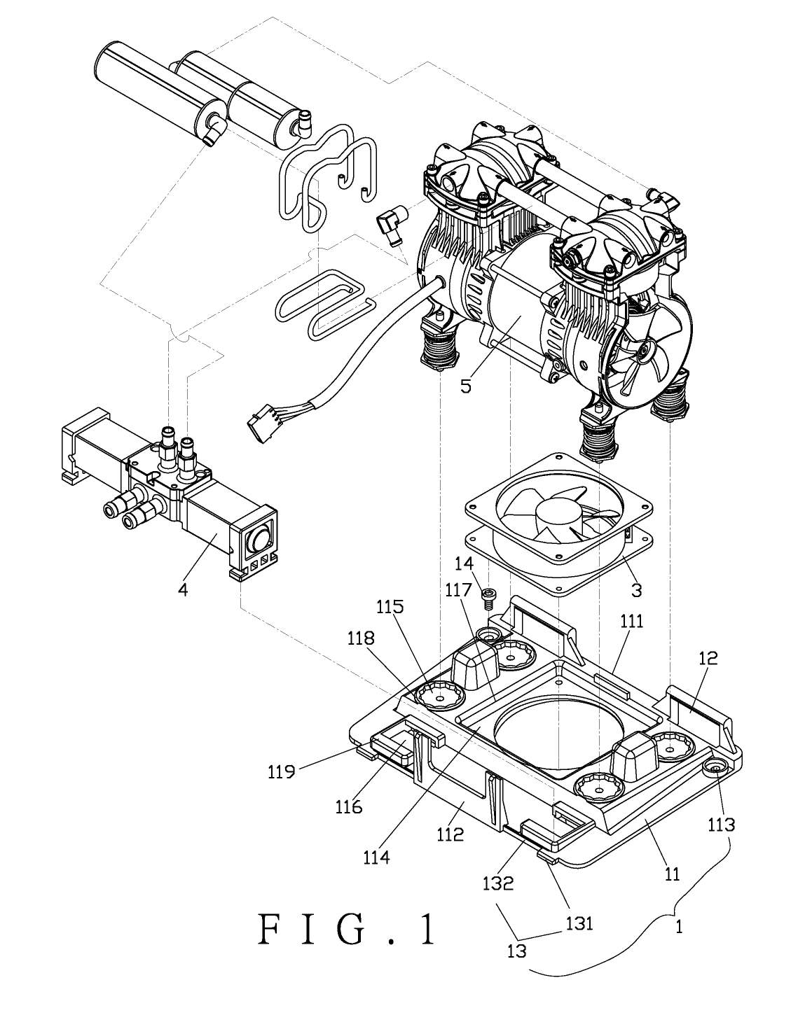

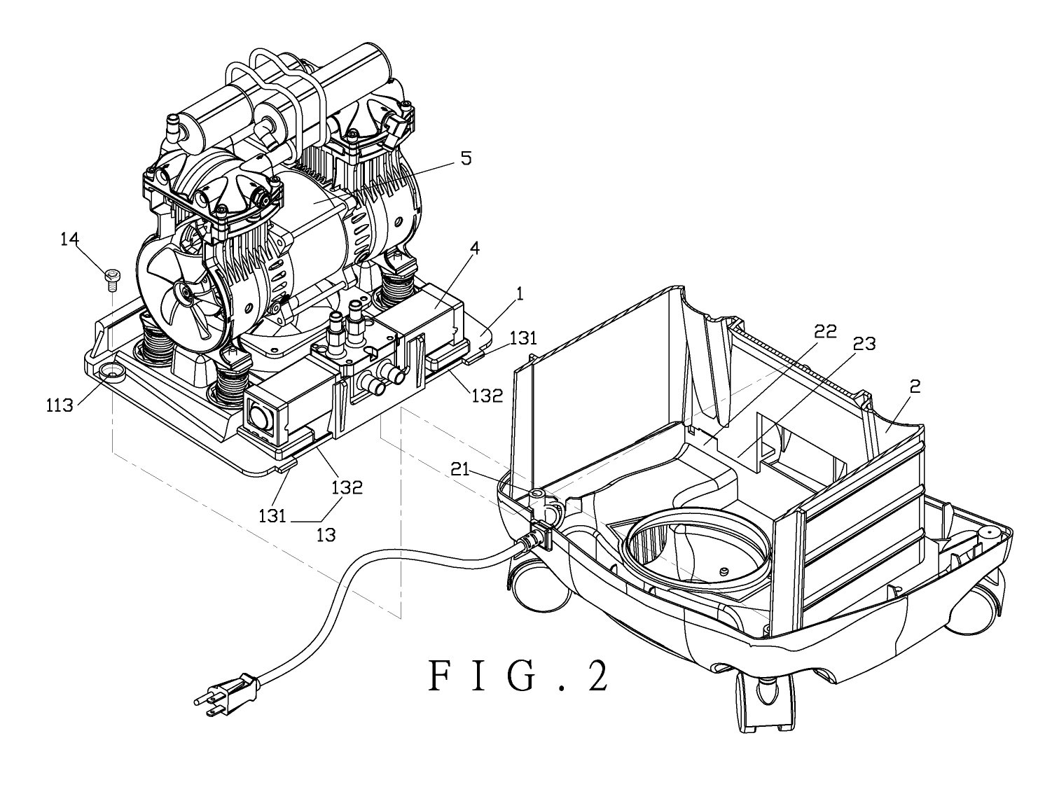

As shown in FIGS. 1 and 2, a preferred embodiment of the present invention comprises a maintenance tray 1 in conjunction with a case 2, a fan 3, an electromagnetic valve 4 and a compressor 5.

The maintenance tray 1 comprises a base board 11, a pair of handles 12, a pair of locators 13 and fasteners 14. The base board 11 comprises a front end 111 and a relative rear end 112. The handles 12 are disposed at the front end 111. The locators 13 are disposed at the rear end 112. The fasteners 14 are to secure the base board 11 to the case 2. The fastener 14 may be bolts or cotters. In this embodiment, the fasteners 14 are bolts. The base board 11 is formed with through holes 113 for insertion of the fasteners 14. The base board 11 comprises locating recesses 114, 115 and 116 and/or locating ribs 117, 118 and 119 to secure the fan 3, the electromagnetic valve 4 and the compressor 5 to the maintenance tray 1. Should the base board 11 comprises only the locating recesses 114, 115 and 116 or only the locating ribs 117, 118 and 119, the fan 3, the electromagnetic valve 4 and the compressor 5 can still be secured to the maintenance tray 1. In this embodiment, the locating recesses and the locating ribs are formed on the base board 11. Each of the locators 13 may be formed with a protuberance 131 and/or a rib 132.

The case 2 comprises locking holes, locating holes 22 and stop plates 23. When the fasteners 14 are bolts, the locking holes of the case 2 are threaded holes 21. The threaded holes 21 correspond in position to the through holes 113 of the base board 11. The locating holes 22 and the stop plates 23 correspond in position to the locators 13. The locating hole 22 corresponds to the protuberance 131, while the stop plate 23 corresponds to the rib 132. When the fasteners 14 are cotters, the locking holes of the case 2 may be threaded holes 21 or through holes for connecting purpose.

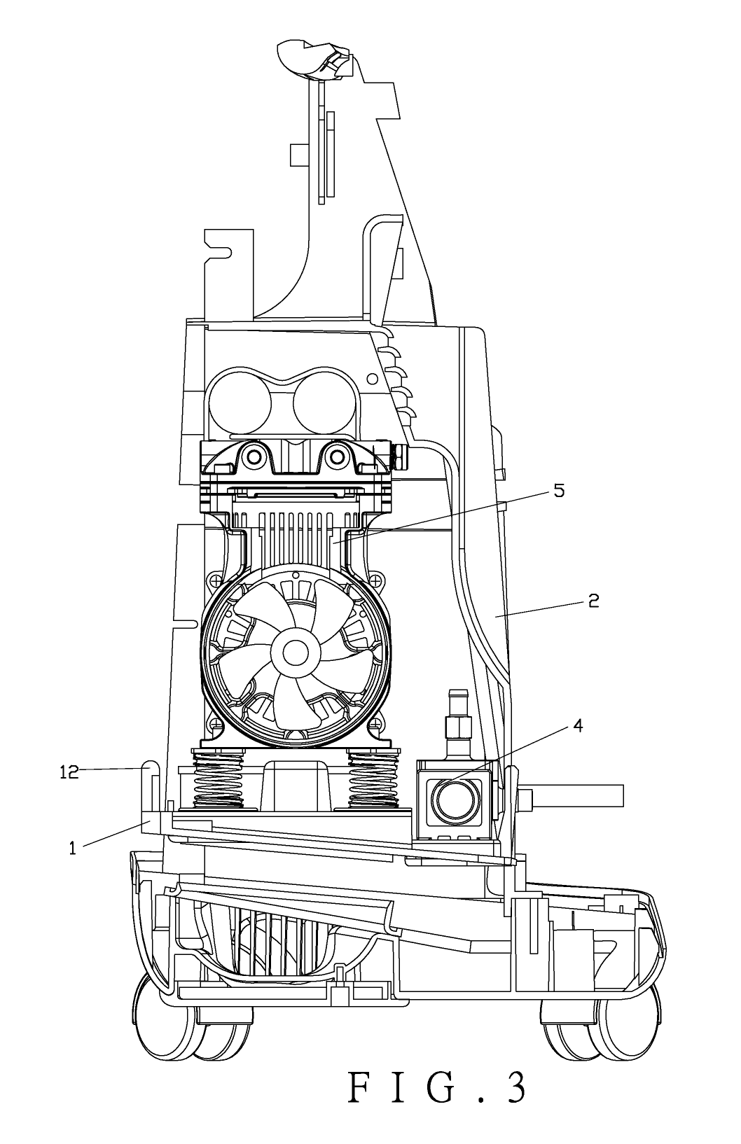

To operate the present invention, as shown in FIG. 3, the fasteners 14 are dismantled and the handles 12 are pulled to lift the maintenance tray 1 upwardly. The fan 3, the electromagnetic valve 4 and the compressor 5 secured on the maintenance tray 1 are exposed, which is convenient for technician to do the maintenance or to repair. When the maintenance job is done, the handles 12 are pushed to return the maintenance tray 1 back into the case 2. When the locators 13 of the base board 11 reach to the case 2, the protuberances 131 will be inserted into the locating holes 22 of the case 2 and the ribs 132 will engage with the stop plates 23 of the case 2, thus the maintenance tray 1 is secured with the case 2. In this embodiment, the fasteners 14 are inserted through the through holes 113 of the base board 11 and secured to the threaded holes 21 of the case 2 so as to complete the installation of the present invention.

What is claimed is:

1. A maintenance tray of an oxygen machine, said maintenance tray being secured to a case, said case comprising locking holes, locating holes and stop plates, said maintenance tray comprising:
a base board having a front end, a rear end and through holes in relation to said locking holes of said case;
a pair of handles formed at said front end of said base board;
a pair of locators formed at said rear end of said base board comprising protuberances and ribs, said protuberances corresponding in position to said locating holes of said case, and said ribs corresponding in position to said stop plates of said case;
fasteners being inserted through said through holes of said base board and secured to said locking holes of said case.

2. The maintenance tray of an oxygen machine, as recited in claim 1, wherein said fasteners are bolts and said locking holes of said case are threaded holes.

3. The maintenance tray of an oxygen machine, as recited in claim 1, wherein said fasteners are cotters and said locking holes of said case are through holes.

4. The maintenance tray of an oxygen machine, as recited in claim 1, wherein said base board comprises recesses.

5. The maintenance tray of an oxygen machine, as recited in claim 1, wherein said base board comprises locating ribs.

6. An oxygen machine having a maintenance tray, the oxygen machine comprising a case, a fan, an electromagnetic valve and a compressor, said case comprising locking holes, locating holes and stop plates, the maintenance tray comprising:
a base board having a front end, a rear end and through holes in relation to said locking holes of said case, the fan, the electromagnetic valve and the compressor being secured to said base board;
a pair of handles formed at said front end of said base board;
a pair of locators formed at said rear end of said base board comprising protuberances and ribs, said protuberances corresponding in position to said locating holes of said case, and said ribs corresponding in position to said stop plates of said case;
fasteners being inserted through said through holes of said base board and secured to said locking holes of said case.

7. The oxygen machine having a maintenance tray, as recited in claim 6, wherein said fasteners are bolts and said locking holes of said case are threaded holes.

8. The oxygen machine having a maintenance tray, as recited in claim 6, wherein said fasteners are cotters and said locking holes of said case are through holes.

9. The oxygen machine having a maintenance tray, as recited in claim 6, wherein said base board comprises recesses.

10. The oxygen machine having a maintenance tray, as recited in claim 6, wherein said base board comprises locating ribs.
